(19) United States
(12) Patent Application Publication
(10) Pub. No.: US 2024/0349335 A1
(43) Pub. Date: Oct. 17, 2024

(54) METHOD AND APPARATUS FOR SIDELINK COMMUNICATION IN UNLICENSED BAND

(71) Applicants: HYUNDAI MOTOR COMPANY, Seoul (KR); KIA CORPORATION, Seoul (KR)

(72) Inventor: Ui Hyun Hong, Hwaseong-si (KR)

(73) Assignees: HYUNDAI MOTOR COMPANY, Seoul (KR); KIA CORPORATION, Seoul (KR)

(21) Appl. No.: 18/752,048

(22) Filed: Jun. 24, 2024

Related U.S. Application Data
(63) Continuation of application No. PCT/KR2022/021105, filed on Dec. 22, 2022.

(30) Foreign Application Priority Data
Jan. 7, 2022 (KR) 10-2022-0002607
Apr. 15, 2022 (KR) 10-2022-0046600

(51) Int. Cl. H04W 74/0808; H04W 74/00; H04W 92/18

(52) U.S. Cl. CPC H04W 74/0808; H04W 74/002; H04W 92/18

(57) ABSTRACT

A method and an apparatus for sidelink communication in an unlicensed band are disclosed. The method by a first UE comprises the steps of: receiving information indicating a timing of performing an LBT operation in a sidelink; performing the LBT operation in an AGC symbol indicated by the information, a symbol next to the AGC symbol, or a symbol not including a PSSCH; and performing a sidelink communication when a result of the LBT operation is an idle state.

### TECHNICAL FIELD

The present disclosure relates to a sidelink communication technique, and more particularly, to a sidelink communication technique in an unlicensed band.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, sidelink communication can be performed in an unlicensed band. A terminal may acquire a channel occupancy time (COT) by performing a listen before talk (LBT) operation, and perform sidelink communication within the acquired COT. However, methods for performing the LBT operation to acquire a COT in an unlicensed band have not been clearly defined.

### DISCLOSURE

### Technical Problem

The present disclosure is directed to providing a method and an apparatus for sidelink communication in an unlicensed band.

### Technical Solution

A method of a first user equipment (UE), according to a first exemplary embodiment of the present disclosure for achieving the above-described objective, may comprise: receiving information indicating a time of performing a listen before talk (LBT) operation in a sidelink; performing the LBT operation in an automatic gain control (AGC) symbol indicated by the information, a symbol next to the AGC symbol, or a symbol not including a physical sidelink shared channel (PSSCH); and in response that a result of the LBT operation indicating an idle state, performing sidelink communication.

The indicating the timing of performing the LBT operation may be received from a base station or a second UE, and the information indicating the timing of performing the LBT operation may be received through at least one of system information, radio resource control (RRC) message, medium access control (MAC) message, or physical (PHY) message.

The method may further comprise: in response that the result of the LBT operation indicating the idle state, configuring a channel occupancy time (COT), wherein the COT may be configured in a slot in which the LBT operation is performed or a slot next to the slot in which the LBT operation is performed, and the sidelink communication may be performed within the COT.

The method may further comprise: receiving information indicating to configure a COT, wherein the LBT operation may be performed when the COT is indicated to be configured, and the COT may be configured when the result of the LBT operation indicates the idle state.

The information indicating to configure the COT may be included in at least one of system information, RRC message, MAC message, or PHY message.

The LBT operation may be performed at a specific time within a symbol, and the specific time may be indicated by the information indicating the time of performing the LBT operation.

The LBT operation may be performed in one or more subchannels, and information indicating the one or more subchannels may be received from a base station or a second UE.

The LBT operation may be performed in one subchannel including a physical sidelink control channel (PSCCH), and the sidelink communication may be performed in one or more subchannels.

When the AGC symbol is a symbol 0, the symbol next to the AGC symbol is a symbol 1, and the LBT operation is performed in the symbol next to the AGC symbol, a demodulation reference signal (DMRS) may be configured in a symbol 2 instead of the symbol 1.

When the AGC symbol is a symbol 0, the symbol next to the AGC symbol is a symbol 1, and the LBT operation is performed in the symbol next to the AGC symbol, a PSCCH may be configured in symbols 2 and 3, and the PSCCH may not be transmitted in the symbol 1.

A first UE, according to a second exemplary embodiment of the present disclosure for achieving the above-described objective, may comprise: a processor, and the processor may cause the first UE to perform: receiving information indicating a time of performing a listen before talk (LBT) operation in a sidelink; performing the LBT operation in an automatic gain control (AGC) symbol indicated by the information, a symbol next to the AGC symbol, or a symbol not including a physical sidelink shared channel (PSSCH); and in response that a result of the LBT operation indicating an idle state, performing sidelink communication.

The information indicating the timing of performing the LBT operation may be received from a base station or a second UE, and the information indicating the timing of performing the LBT operation may be received through at least one of system information, radio resource control (RRC) message, medium access control (MAC) message, or physical (PHY) message.

The processor may further cause the first UE to perform: in response that the result of the LBT operation indicating the idle state, configuring a channel occupancy time (COT), wherein the COT may be configured in a slot in which the LBT operation is performed or a slot next to the slot in which the LBT operation is performed, and the sidelink communication may be performed within the COT.

The processor may further cause the first UE to perform: receiving information indicating to configure a COT, wherein the LBT operation may be performed when the COT is indicated to be configured, and the COT may be configured when the result of the LBT operation indicates the idle state.

The information indicating to configure the COT may be included in at least one of system information, RRC message, MAC message, or PHY message.

The LBT operation may be performed at a specific time within a symbol, and the specific time may be indicated by the information indicating the time of performing the LBT operation.

The LBT operation may be performed in one or more subchannels, and information indicating the one or more subchannels may be received from a base station or a second UE.

The LBT operation may be performed in one subchannel including a physical sidelink control channel (PSCCH), and the sidelink communication may be performed in one or more subchannels.

When the AGC symbol is a symbol 0, the symbol next to the AGC symbol is a symbol 1, and the LBT operation is performed in the symbol next to the AGC symbol, a demodulation reference signal (DMRS) may be configured in a symbol 2 instead of the symbol 1.

When the AGC symbol is a symbol 0, the symbol next to the AGC symbol is a symbol 1, and the LBT operation is performed in the symbol next to the AGC symbol, a PSCCH may be configured in symbols 2 and 3, and the PSCCH may not be transmitted in the symbol 1.

### Advantageous Effects

According to the present disclosure, a time for performing an LBT operation in sidelink can be indicated, and a terminal can initiate a COT by performing the LBT operation at the indicated time, subsequently engaging in SL communication within the COT. Therefore, SL communication can be conducted efficiently, thereby enhancing the performance of the communication system.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a conceptual diagram illustrating a first exemplary embodiment of downlink communication and/or uplink communication in an unlicensed band.

FIG. 10 is a conceptual diagram illustrating a first exemplary embodiment of sidelink communication in an unlicensed band.

FIG. 11 is a conceptual diagram illustrating a second exemplary embodiment of sidelink communication in an unlicensed band.

FIG. 12 is a conceptual diagram illustrating a third exemplary embodiment of sidelink communication in an unlicensed band.

FIG. 13 is a conceptual diagram illustrating a fourth exemplary embodiment of sidelink communication in an unlicensed band.

FIG. 14 is a conceptual diagram illustrating a first exemplary embodiment of a slot structure in sidelink communication.

FIG. 15 is a conceptual diagram illustrating a first exemplary embodiment of a subchannel structure in sidelink communication.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

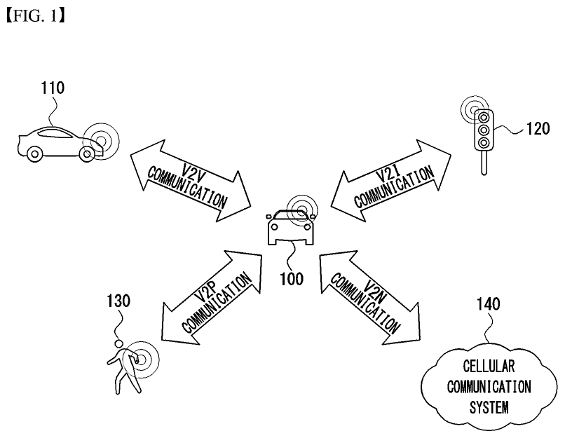

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In the instant case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In the instant case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In the instant case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

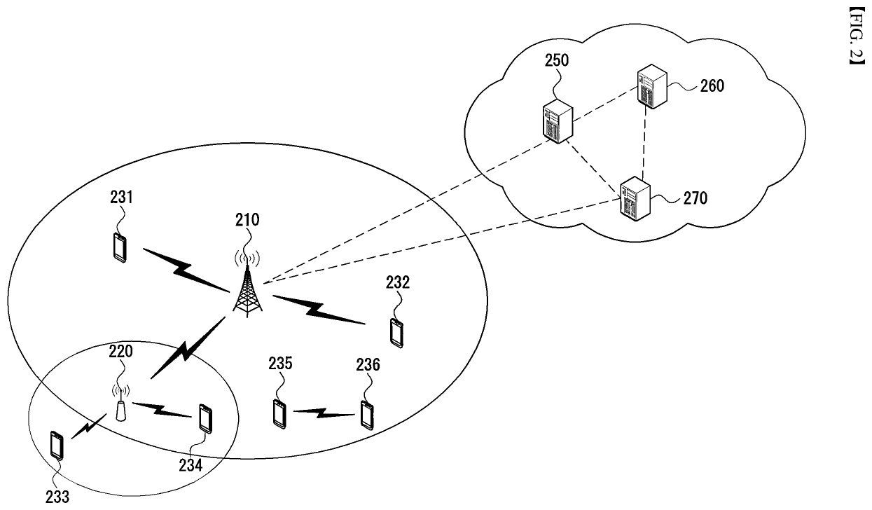

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

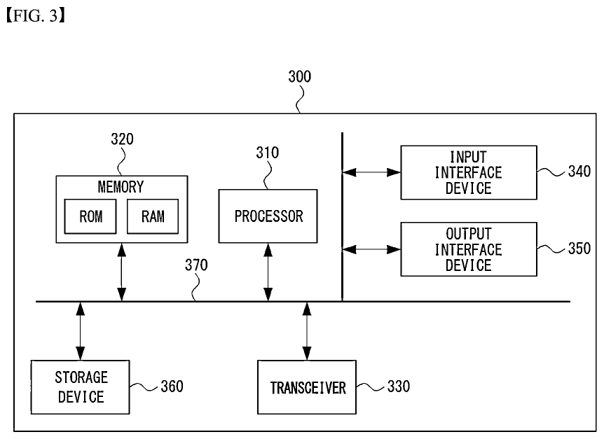

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

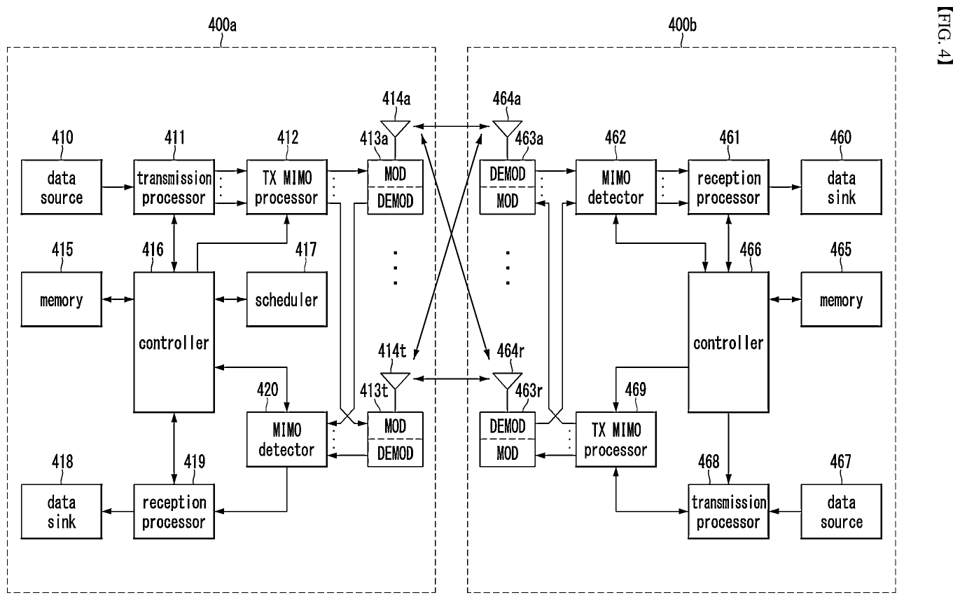

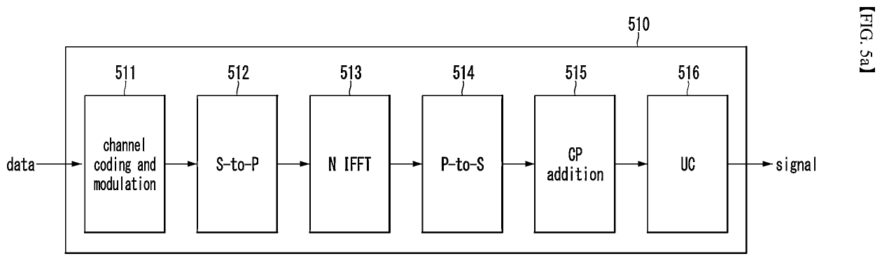

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of | Out of coverage of |
| | base station 210 | base station 210 |
| C | In coverage of | In coverage of |
| | base station 210 | base station 210 |
| D | In coverage of | In coverage of |
| | base station 210 | other base station |

Meanwhile, a user plane protocol stack of the UEs (e.g., the UEs 235 and 236) performing sidelink communications may be configured as follows.

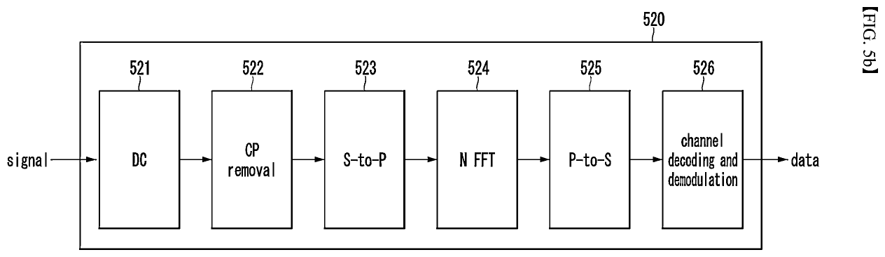

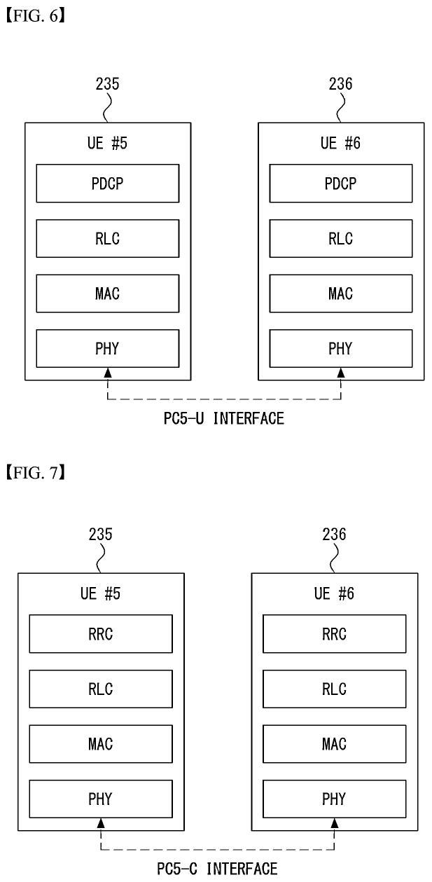

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

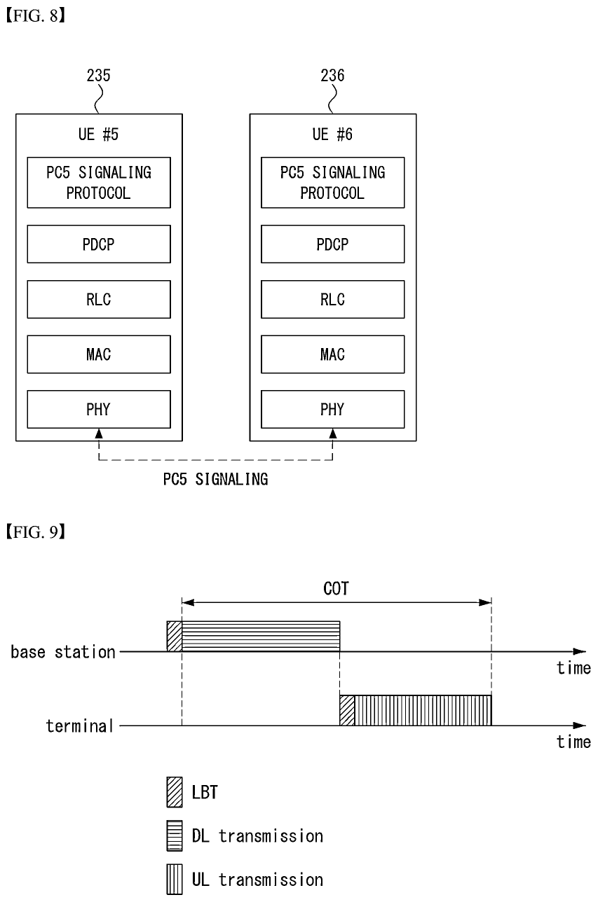

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources |
| | scheduled by base station |
| 2 | UE autonomous transmission without |
| | scheduling of base station |
| 3 | Transmission using resources scheduled |
| | by base station in V2X communications |
| 4 | UE autonomous transmission without scheduling |
| | of base station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In the instant case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In the instant case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In the instant case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In the instant case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e. sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In the instant case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In the instant case, the SCI format 2-C may include at least one among a priority, number of subchannels, resource reservation period, resource selection window location, resource set type, or padding bit(s).

Meanwhile, downlink communication, uplink communication, and/or sidelink communication may be performed in an unlicensed band. Downlink communication and/or uplink communication band may be performed in an unlicensed as follows.

FIG. 9 is a conceptual diagram illustrating a first exemplary embodiment of downlink communication and/or uplink communication in an unlicensed band.

As shown in FIG. 9, a base station may obtain a channel occupancy time (COT) by performing an LBT operation in an unlicensed band. When a result of the LBT operation indicates an idle state, the base station may initiate a COT. The base station may perform downlink (DL) transmission within the COT. A terminal may perform uplink (UL) transmission within the COT initiated by the base station. The terminal may perform an LBT operation to perform UL transmission. Alternatively, an LBT operation of the terminal may not be performed within the COT. The COT initiated by the base station may be shared with the terminal. LBT operations may be classified according to categories as shown in Table 3 below.

TABLE 3

| | Description |
|---|---|
| Category 1 | Immediate transmission after a short |
| | switching gap. That, is an LBT operation |
| | is not performed |
| Category 2 | LBT operation without a random backoff |
| Category 3 | LBT operation with a random backoff |
| | having a contention window of a fixed size |
| Category 4 | LBT operation with a random backoff having |
| | a contention window of a variable size |

The LBT operation may mean a clear channel assessment (CCA) operation. In the CCA operation, a communication node (e.g., base station or terminal) may determine a state of a channel (e.g., busy state or idle state) based on an energy detection (ED) scheme. The busy state may mean that another signal exists in the channel. The idle state may mean that no other signals are present in the channel. Alternatively, the idle state may mean that a reception strength of other signals in the channel is less than a threshold. Before using the channel, the communication node may determine a channel state (e.g., idle state or busy state) by performing the LBT operation (e.g., CCA operation). After determining the channel state, the communication node may apply a specific rule. If an energy detected during a CCA period is below a threshold (e.g., ED threshold), the communication node may determine the channel state to be in the idle state and access the channel during the COT.

For communication in an unlicensed band, the communication node may identify the channel state by performing an LBT operation, and transmit data when the channel state is the idle state. The communication node may perform data transmission and reception operations by continuously utilizing the channel during the COT. The COT may be configured to have a length equal to or shorter than a maximum COT (MCOT). A slot duration of CCA may be 5 us to 9 us. MCOT may be 8 ms.

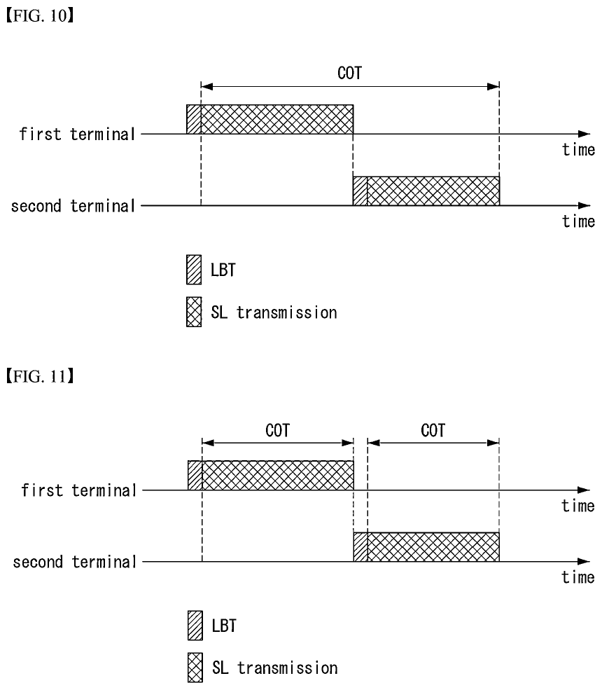

FIG. 10 is a conceptual diagram illustrating a first exemplary embodiment of sidelink communication in an unlicensed band.

As shown in FIG. 10, a first terminal may configure a COT. For example, when a result of an LBT operation indicates the idle state, the first terminal may initiate a COT. The COT may be configured to have a length (e.g., duration) required for a transmission operation (e.g., data transmission operation) of the first terminal and a transmission operation of a response (e.g., PSFCH, CSI report) of a second terminal for the corresponding transmission operation or a transmission operation (e.g., data transmission operation) of the second terminal. The first terminal may transmit data to the second terminal within the COT. The second terminal may receive the data from the first terminal. The second terminal may perform SL communication within the COT initiated by the first terminal.

FIG. 11 is a conceptual diagram illustrating a second exemplary embodiment of sidelink communication in an unlicensed band.

As shown in FIG. 11, each terminal may configure (e.g., initiate) a COT. For example, a first terminal may initiate a first COT and perform SL communication (e.g., data transmission operation) within the first COT. A second terminal may initiate a second COT and perform SL communication (e.g., data transmission operation) within the second COT. Each of the first COT and the second COT may be configure when a result of an LBT operation indicates the idle state. Each of the first COT and the second COT may be configured independently. The first COT and the second COT may overlap partially in the time domain. In the instant case, the first terminal may perform SL communication in a period excluding an overlapping period within the first COT, and the second terminal may perform SL communication in a period excluding the overlapping period within the second COT.

The COT may be configured according to a specific condition (e.g., cast type, priority, packet delay budget (PDB)). For example, a COT for unicast communication may be configured as the COT shown in FIG. 10. The COT shown in FIG. 10 may be shared among terminals. A COT for groupcast communication or broadcast communication may be configured as the COT shown in FIG. 11. In exemplary embodiments, the COT may refer to the MCOT. The COT shown in FIG. 11 may not be shared among terminals.

In sidelink communication, a COT (or MCOT) may be configured in time units (e.g., ms) or slot units. For example, the terminal may perform an LBT operation in a specific period within a slot N, and when a result of the LBT operation indicates the idle state, a time from a slot N+1 to a slot N+X may be configured as the COT. N may be an integer equal to or greater than 0, and X may be an integer equal to or greater than 2. A period of a COT may be configured by the base station, and the terminal may configure a COT with the period indicated by the base station. The specific period in which the LBT operation is performed may start at a start time of a slot (e.g., slot N) or at an arbitrary time within the slot. The specific period in which the LBT operation is performed may end at an end time of a slot (e.g., slot N) or at an arbitrary time within the slot.

A value of X (e.g., value indicating an end time of the COT) may be preconfigured for each resource pool. Alternatively, a value of X (e.g., value indicating an end time of the COT) may be transmitted through at least one of system information, higher layer signaling (e.g., RRC signaling), MAC message (e.g., MAC CW), or PHY message (e.g., first-stage SCI and/or second-stage SCI). When the COT is configured on a slot basis, the first symbol of the COT may be an automatic gain control (AGC) symbol. A start period and/or end period of the COT may be configured on a symbol basis rather than a slot basis. For example, a start slot and/or end slot of the COT may be a partial slot. The partial slot may include less than 14 symbols.

In exemplary embodiments, configuration of a COT may mean initiation of the COT. In addition, configuration of a COT may mean that the COT is configurable in all or part of a resource pool, time resource, and/or frequency resource. In exemplary embodiments, terminals operating in an unlicensed band may be assumed to be synchronized.

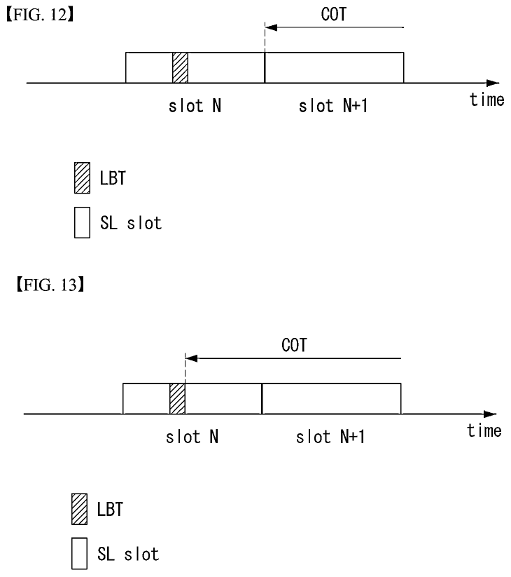

FIG. 12 is a conceptual diagram illustrating a third exemplary embodiment of sidelink communication in an unlicensed band.

As shown in FIG. 12, a terminal may perform an LBT operation in an arbitrary period within a slot N. If a result of the LBT operation indicates the idle state, the terminal may configure a COT starting from a slot N+1. That is, the COT may be configured in a slot next to the slot in which the LBT operation is performed. In the instant case, a latency may occur between an end time of the LBT operation and a start time of the COT. Since SL communication is not performed in a period from the end time of the LBT operation to the start time of the COT, the period may be wasted. In order to solve the above-mentioned problems, a period in which an LBT operation is performed within a slot may be limited to a specific period (e.g., specific symbol(s)). Alternatively, the COT may be initiated from an end time of the LBT operation.

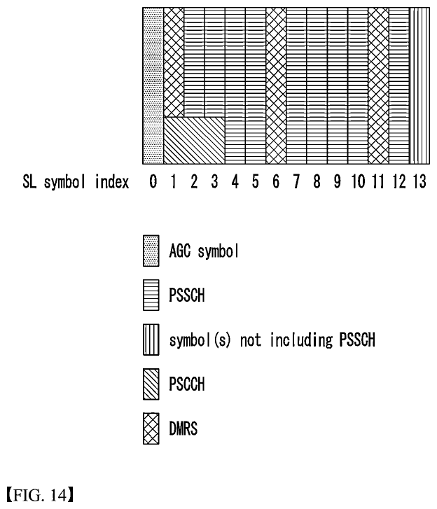

FIG. 13 is a conceptual diagram illustrating a fourth exemplary embodiment of sidelink communication in an unlicensed band.

As shown in FIG. 13, a terminal may perform an LBT operation in an arbitrary period within a slot N. When a result of the LBT operation indicates the idle state, the terminal may configure a COT from an end time of the LBT operation. That is, the COT may be configured in the slot where the LBT operation is performed. A start slot of the COT may be a partial slot.

FIG. 14 is a conceptual diagram illustrating a first exemplary embodiment of a slot structure in sidelink communication.

As shown in FIG. 14, the remaining symbols within a slot, excluding an AGC symbol and a gap symbol, may be used for PSCCH transmission, PSSCH transmission, and DMRS transmission. The AGC symbol may refer to a symbol used for AGC operations. The AGC symbol may be a symbol 0 within the slot. The gap symbol may be a symbol 13 within the slot and may not include a PSSCH. A PSCCH symbol may refer to a symbol used for PSCCH transmission. A PSSCH symbol may refer to a symbol used for PSSCH transmission. The DMRS symbol may refer to a symbol used for DMRS transmission.

An LBT operation in a sidelink may be performed at locations defined in Table 4 below. Considering a slot duration of CCA, the LBT operation may be performed within one symbol (e.g., 71.4 us) based on an SCS 15 kHz. The LBT operation may be similarly applied to other SCSs.

TABLE 4

| | Description |
|---|---|
| AGC symbol (e.g., symbol 0) | The LBT operation may be performed in a part |
| | (e.g., a front half or a back half) of the AGC symbol. |
| Next symbol of the | The LBT operation may be perform in a symbol |
| AGC symbol | next to the AGC symbol. |
| (e.g., symbol 1) | When the symbol (e.g., symbol 1) next to the AGC symbol is a |
| | DMRS symbol, the DMRS may be transmitted (e.g., configured |
| | or arranged) in a symbol 2 rather than the symbol 1. |
| | A PSCCH may be transmitted (e.g., configured or arranged) in the |
| | symbols 2 and 3. That is, the PSCCH may not be transmitted in |
| | the symbol 1. |
| | When the LBT operation is performed, at least two PSCCH |
| | symbols may be guaranteed. |
| Symbol(s) not | The LBT operation may be performed in the last symbol or the |
| including PSSCH | first symbol among symbol(s) not including a PSSCH within the |
| | slot. For example, the LBT operation may be performed in a part |
| | (e.g., a front half or a back half)) of the last symbol or the first |
| | symbol described above. |

Information indicating a time of performing the LBT operation (e.g., information defined in Table 4) may indicate a specific time with the symbol. In the instant case, the information indicating the time of performing the LBT operation may include information indicating the symbol in which the LBT operation is performed and an offset between a start time of the symbol and the specific time at which the LBT operation is performed. The base station may transmit the information indicating the time of performing the LBT operation in the unlicensed band (e.g., information defined in Table 4) to terminal(s) using at least one of system information, RRC message, MAC message, or PHY message. The terminal(s) may identify the time of performing the LBT operation based on the information received from the base station and perform the LBT operation at the identified time. When a result of the LBT operation indicates the idle state, a COT may be configured (e.g., initiated), and SL communication may be performed within the COT.

Alternatively, a terminal may transmit information indicating a time of performing an LBT operation in an unlicensed band (e.g., information defined in Table 4) to other terminal(s) by using at least one of system information, RRC message, MAC message, or PHY message. Terminal(s) may identify the time of performing the LBT operation based on the information received from another terminal, and perform the LBT operation at the identified time. When a result of the LBT operation indicates the idle state, a COT may be configured (e.g., initiated), and SL communication may be performed within the COT.

In exemplary embodiments, a symbol before a specific symbol may refer to a symbol before an offset from the specific symbol, and a symbol after a specific symbol (e.g., the next symbol of the specific symbol) may refer to a symbol after an offset from the specific symbol. A COT of the sidelink may be configured using the same time unit or a different time unit from a downlink/uplink COT.

A COT in a sidelink may be indicated. For example, a first terminal may transmit SCI (e.g., first-stage SCI and/or second-stage SCI) including information indicating to configure (e.g., initiate) a COT. The information indicating to configure a COT may be a 1-bit indicator. A second terminal may receive the SCI from the first terminal and identify the information included in the SCI. When the SCI indicates to configure a COT, the second terminal may configure (e.g., initiate) a COT. The second terminal may configure the COT from a slot in which the SCI (e.g., SCI indicating to configure the COT) is received or a next slot of the slot. In the instant case, the second terminal may perform an LBT operation to configure the COT, and may configure the COT when a result of the LBT operation indicates the idle state. A time of performing the LBT operation may be indicated as in the exemplary embodiment according to Table 4 or Table 5. In addition, the first terminal transmitting the SCI (e.g., SCI indicating to configure the COT) may configure a COT from a slot in which the SCI is transmitted or a slot next to the slot in which the SCI is transmitted. In the instant case, the first terminal may perform an LBT operation to configure the COT, and may configure the COT when a result of the LBT operation indicates the idle state. The time of performing the LBT operation may be indicated as in the exemplary embodiment according to Table 4 or Table 5.

Alternatively, a base station may transmit information indicating to configure (e.g., initiate) a COT in a sidelink to terminal(s) using at least one of system information, RRC message, MAC message, or PHY message. The terminal(s) may configure (e.g., initiate) a COT based on the information received from the base station. In the instant case, the terminal(s) may perform an LBT operation to configure the COT, and may configure the COT when a result of the LBT operation indicates the idle state. A time of performing the LBT operation may be indicated as in the exemplary embodiment according to Table 4 or Table 5.

Alternatively, a terminal may transmit information indicating to configure (e.g., initiate) a COT in a sidelink to other terminal(s) using at least one of system information, RRC message, MAC message, or PHY message. Terminal(s) may configure (e.g., initiate) a COT based on the information received from another terminal. In the instant case, the terminal(s) may perform an LBT operation to configure the COT, and may configure the COT when a result of the LBT operation indicates the idle state. A time of performing the LBT operation may be indicated as in the exemplary embodiment according to Table 4 or Table 5.

Meanwhile, a first terminal may initiate a COT by performing an LBT operation and transmit SCI to a second terminal within the COT. The SCI may include information indicating to share the COT initiated by the first terminal. In the instant case, the second terminal receiving the SCI of the first terminal may perform SL communication within the COT initiated by the first terminal without securing a separate COT. The SCI may further include inter-UE coordination information. The inter-UE coordination information may indicate a preferred COT or non-preferred COT. When the inter-UE coordination information indicates a preferred COT, the second terminal receiving the SCI including the inter-UE coordination information may perform SL communication within the preferred COT. When the inter-UE coordination information indicates a non-preferred COT, the second terminal receiving the SCI including the inter-UE coordination information may perform SL communication using resources other than the non-preferred COT.

When parameters related to operations in the unlicensed band (e.g., a start time of operations in the unlicensed band, end time of the operations, periodicity of the operations, bitmap related to operating bands) are received through signaling, the corresponding operation may be performed in the unlicensed band.

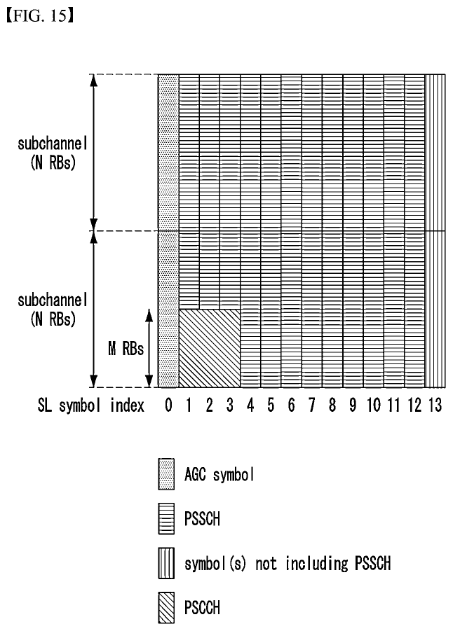

FIG. 15 is a conceptual diagram illustrating a first exemplary embodiment of a subchannel structure in sidelink communication.

As shown in FIG. 15, the size of a subchannel in sidelink may be N physical resource blocks (PRBs) or N resource blocks (RBs). N may be 10, 12, 15, 20, 25, 50, 70, or 100. The size of a PSCCH (e.g., the size of a subchannel for a PSCCH) may be M PRBs or M RBs. M may be 10, 12, 15, 20, or 25. M may be equal to or less than N.

When the size of a data unit to be transmitted in the unlicensed band is small and/or when it is necessary to reduce signaling overhead (e.g., the number of bits required for signaling) for unlicensed band operations, the LBT operation in the sidelink (e.g., LBT operation for one subchannel) may be performed at locations defined in Table 5 below. Through the LBT operation, an operation in the unlicensed band may be allowed in one subchannel (e.g., subchannel including a PSCCH). For example, the LBT operation may be performed in one subchannel (e.g., subchannel including the PSCCH) among a plurality of subchannels, and when a result of the LBT operation indicates the idle state, communication (e.g., SL communication) may be performed in one or more subchannels in the unlicensed band (e.g., subchannel including the PSCCH or ‘subchannel including the PSCCH+other subchannel(s)’).

TABLE 5

| | Description |
|---|---|
| AGC symbol (e.g., symbol 0) | The LBT operation may be performed in a part (e.g., a front |
| in a subchannel | half or a back half) of the AGC symbol in a subchannel |
| including a PSCCH | including a PSCCH. |
| A symbol (e.g., symbol 1) | The LBT operation may be perform in a symbol next to the |
| next to the AGC symbol in | AGC symbol in a subchannel including a PSCCH. |
| a subchannel including a | When the symbol (e.g., symbol 1) next to the AGC symbol |
| PSCCH | is a DMRS symbol, the DMRS may be transmitted (e.g., |
| | configured or arranged) in a symbol 2 rather than the symbol |
| | 1. The PSCCH may be transmitted (e.g., configured or |
| | arranged) in the symbols 2 and 3. That is, the PSCCH may |
| | not be transmitted in the symbol 1. |
| | When the LBT operation is performed, at least two PSCCH |
| | symbols may be guaranteed. |
| Symbol(s) not including a | The LBT operation may be performed in the last symbol or |
| PSSCH in a subchannel | the first symbol among symbol(s) not including a PSSCH |
| including a PSCCH | within the slot. For example, the LBT operation may be |
| | performed in a part (e.g., a front half or a back half)) of the |
| | last symbol or the first symbol described above. |

Information indicating a time of performing the LBT operation (e.g., information defined in Table 5) may indicate a specific time with a symbol. In the instant case, the information indicating the time of performing the LBT operation may include information indicating the symbol in which the LBT operation is performed and an offset between a start time of the symbol and the specific time at which the LBT operation is performed. The base station may transmit the information indicating the time of performing the LBT operation in the unlicensed band (e.g., information defined in Table 5) to terminal(s) using at least one of system information, RRC message, MAC message, or PHY message. Terminal(s) may identify the time of performing the LBT operation based on the information received from the base station and perform the LBT operation at the identified time. When a result of the LBT operation indicates the idle state, a COT may be configured (e.g., initiated), and SL communication may be performed within the COT.

Alternatively, a terminal may transmit information indicating a time of performing an LBT operation in an unlicensed band (e.g., information defined in Table 5) to other terminal(s) by using at least one of system information, RRC message, MAC message, or PHY message. Terminal(s) may identify the time of performing the LBT operation based on the information received from another terminal, and perform the LBT operation at the identified time. When a result of the LBT operation indicates the idle state, a COT may be configured (e.g., initiated), and SL communication may be performed within the COT.

The LBT operation may be performed on a plurality of subchannels. The terminal may simultaneously perform the LBT operations on the plurality of subchannels, identify one or more subchannels for which a result of the LBT operation indicates the idle state among the plurality of subchannels, and perform SL communication (e.g., data transmission) in one subchannel among the one or more subchannels. Alternatively, the terminal may sequentially perform the LBT operation on the plurality of subchannels. For example, the terminal may perform an LBT operation in a first subchannel and then perform an LBT operation in a second subchannel. When a result of the LBT operation in the first subchannel indicates the busy state, the LBT operation may be performed in the second subchannel. When a result of the LBT operation in the first subchannel indicates the idle state, the LBT operation may not be performed in the second subchannel.

The base station or terminal may transmit information indicating subchannel(s) in which the LBT operation is performed to terminal(s) using at least one of system information, RRC message, MAC message, or PHY message. The information indicating the subchannel(s) in which the LBT operation is performed may include at least one of index(es) of the subchannel(s), the number of the subchannel(s), an index of a start subchannel, an index of an end subchannel, or an offset between the start subchannel and the end subchannel. The terminal may identify the subchannel(s) in which the LBT operation is performed based on the information received from the base station or another terminal, and perform the LBT operation in the subchannel(s).

Within a SL BWP, a BWP for unlicensed band operations may be configured separately. The BWP for unlicensed band operations may be configured for each resource pool. In exemplary embodiments, SCI may mean first-stage SCI and/or second-stage SCI.

The above-described information for unlicensed band operations may be configured specifically, independently, or commonly based on a resource pool, service type, priority, whether power saving operations are performed, QoS parameters (e.g., reliability, latency), cast type, or terminal type (e.g., vehicle (V)-UE or pedestrian (P)-UE). The above-described configuration may be performed by the network and/or base station. Alternatively, the above-described information may be implicitly determined based on preconfigured parameter(s).

In the above-described exemplary embodiments, whether or not to apply each method (e.g., each rule) may be configured based on at least one of a condition, a combination of conditions, a parameter, or a combination of parameters. Whether or not to apply each method may be configured by the network and/or base station. Whether or not to apply each method may be configured resource pool-specifically or service-specifically. Alternatively, whether or not to apply each method may be configured by PC5-RRC signaling between terminals.

Methods according to the present disclosure may be implemented in form of program instructions executable through various computer means, and may be recorded on a computer-readable medium. The computer-readable medium may include the program instructions, data files, data structures, etc., singly or in combination. The program instructions recorded on the computer-readable medium may be specially designed and constructed for the present disclosure or may be known and usable by those skilled in the computer software art.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), the method comprising:
receiving information indicating a time of performing a listen before talk (LBT) operation in a sidelink;
performing the LBT operation in a symbol including at least one selected from an automatic gain control (AGC) symbol indicated by the information, a symbol next to the AGC symbol and a symbol not including a physical sidelink shared channel (PSSCH); and
in response to a result of the LBT operation indicating an idle state, performing sidelink communication.

2. The method of claim 1, wherein the information indicating the timing of performing the LBT operation is received from a base station or a second UE, and the information indicating the timing of performing the LBT operation is received through at least one of system information, radio resource control (RRC) message, medium access control (MAC) message, or physical (PHY) message.

3. The method of claim 1, further comprising: in response to the result of the LBT operation indicating the idle state, configuring a channel occupancy time (COT), wherein the COT is configured in a slot in which the LBT operation is performed or a slot following the slot in which the LBT operation is performed, and the sidelink communication is performed within the COT.

4. The method of claim 1, further comprising: receiving information indicating to configure a COT, wherein the LBT operation is performed when the COT is indicated to be configured, and the COT is configured when the result of the LBT operation indicates the idle state.

5. The method of claim 4, wherein the information indicating to configure the COT is included in at least one of system information, RRC message, MAC message, or PHY message.

6. The method of claim 1, wherein the LBT operation is performed at a specific time within the symbol, and the specific time is indicated by the information indicating the time of performing the LBT operation.

7. The method of claim 1, wherein the LBT operation is performed in one or more subchannels, and information indicating the one or more subchannels is received from a base station or a second UE.

8. The method of claim 1, wherein the LBT operation is performed in one subchannel including a physical sidelink control channel (PSCCH), and the sidelink communication is performed in one or more subchannels.

9. The method of claim 1, wherein when the AGC symbol is a symbol 0 which is a first symbol within the slot, the symbol next to the AGC symbol is a symbol 1 following the symbol 0, and the LBT operation is performed in the symbol next to the AGC symbol, a demodulation reference signal (DMRS) is configured in a symbol 2 following the symbol 1 within the slot instead of the symbol 1.

10. The method of claim 1, wherein when the AGC symbol is a symbol 0 which is a first symbol within the slot, the symbol next to the AGC symbol is a symbol 1 following the symbol 0 within the slot, and the LBT operation is performed in the symbol next to the AGC symbol, a PSCCH is configured in a symbol 2 following the symbol 1 and a symbol 3 following the symbol 2 within the slot, and the PSCCH is not transmitted in the symbol 1.

11. A first user equipment (UE) comprising a processor, wherein the processor causes the first UE to perform:
receiving information indicating a time of performing a listen before talk (LBT) operation in a sidelink;
performing the LBT operation in a symbol including at least one selected from an automatic gain control (AGC) symbol indicated by the information, a symbol next to the AGC symbol and a symbol not including a physical sidelink shared channel (PSSCH); and
in response to a result of the LBT operation indicating an idle state, performing sidelink communication.

12. The first UE of claim 11, wherein the information indicating the timing of performing the LBT operation is received from a base station or a second UE, and the information indicating the timing of performing the LBT operation is received through at least one of system information, radio resource control (RRC) message, medium access control (MAC) message, or physical (PHY) message.

13. The first UE of claim 11, wherein the processor further causes the first UE to perform: in response that the result of the LBT operation indicating the idle state, configuring a channel occupancy time (COT), wherein the COT is configured in a slot in which the LBT operation is performed or a slot following the slot in which the LBT operation is performed, and the sidelink communication is performed within the COT.

14. The first UE of claim 11, wherein the processor further causes the first UE to perform: receiving information indicating to configure a COT, wherein the LBT operation is performed when the COT is indicated to be configured, and the COT is configured when the result of the LBT operation indicates the idle state.

15. The first UE of claim 14, wherein the information indicating to configure the COT is included in at least one of system information, RRC message, MAC message, or PHY message.

16. The first UE of claim 11, wherein the LBT operation is performed at a specific time within the symbol, and the specific time is indicated by the information indicating the time of performing the LBT operation.

17. The first UE of claim 11, wherein the LBT operation is performed in one or more subchannels, and information indicating the one or more subchannels is received from a base station or a second UE.

18. The first UE of claim 11, wherein the LBT operation is performed in one subchannel including a physical sidelink control channel (PSCCH), and the sidelink communication is performed in one or more subchannels.

19. The first UE of claim 11, wherein when the AGC symbol is a symbol 0 which is a first symbol within the slot, the symbol next to the AGC symbol is a symbol 1 following the symbol 0, and the LBT operation is performed in the symbol next to the AGC symbol, a demodulation reference signal (DMRS) is configured in a symbol 2 following the symbol 1 within the slot instead of the symbol 1.

20. The first UE of claim 11, wherein when the AGC symbol is a symbol 0 which is a first symbol within the slot, the symbol next to the AGC symbol is a symbol 1 following the symbol 0 within the slot, and the LBT operation is performed in the symbol next to the AGC symbol, a PSCCH is configured in a symbol 2 following the symbol 1 and a symbol 3 following the symbol 2 within the slot, and the PSCCH is not transmitted in the symbol 1.
